(19) United States
(12) Patent Application Publication
(10) Pub. No.: US 2013/0031451 A1
(43) Pub. Date: Jan. 31, 2013

(54) SYSTEM FOR EFFICIENT DISTRIBUTION AND RETAINED CONTROL OF CONFIDENTIAL RECOMMENDATIONS OF INDIVIDUALS

(71) Applicants: Isaac Rubinstein, Haworth, NJ (US); Ehud Arbit, Englewood, NJ (US); Ziv Harish, Tenafly, NJ (US); Russ Weinzimmer, Milford, NH (US)

(72) Inventors: Isaac Rubinstein, Haworth, NJ (US); Ehud Arbit, Englewood, NJ (US); Ziv Harish, Tenafly, NJ (US); Russ Weinzimmer, Milford, NH (US)

(21) Appl. No.: 13/189,669

(22) Filed: Jul. 25, 2011

(51) Int. Cl. G06F 17/00

(52) U.S. Cl. 715/208; 715/205

(57) ABSTRACT

A website and method are disclosed for helping a recommender to provide confidential recommendations for individuals. The system enables the recommender to efficiently comply with multiple requests for confidential recommendations, and to efficiently comply with a single request for a confidential recommendation to be sent to multiple institutions. The system eliminates the need to write multiple confidential recommendations when the individual applies to multiple institutions by enabling the recommender to distribute multiple links to the same confidential recommendation. The system also enables the recommender to easily edit the recommendation before or after multiple links have been distributed, thereby ensuring that the recommender retains control over the content of the confidential recommendation. The control over the recommendation link also includes a capability for changing the link expiration date, temporarily suspending or re-activating a link, and deleting a link.

### FIELD OF INVENTION

This invention relates generally to recommendation management systems, and more particularly to online confidential recommendation management systems.

### BACKGROUND OF THE INVENTION

There are many recommendations management systems, and most are integrated with academic admissions systems. Applicants for admission use an academic admissions system to apply to a college and to send out requests to potential recommenders, hoping that those recommenders will agree to provide a confidential recommendation of the applicant. Potential recommenders receive, usually over email, a link to a web based system that enables the recommender to write a recommendation for the applicant. When the applicant has obtained enough recommendations, the applicant can continue with the admissions process.

When the same applicant applies for admission to multiple institutions, the recommender is usually asked to complete multiple recommendations, as each institution has a separate admissions system.

A recommender may change his mind, but altering a recommendation after it was submitted is hard, especially after the admissions process starts. It is even harder when a recommended individual applies to multiple colleges, as each college has a separate admissions system.

### SUMMARY OF THE INVENTION

A website and method are disclosed for helping a recommender to provide confidential recommendations for individuals. When an individual repeatedly requests confidential recommendations, as is common when applying to multiple institutions, the system enables the recommender to efficiently comply with the multiple requests. The system also enables the recommender to efficiently comply with a single request for a confidential recommendation to be sent to multiple institutions. The system eliminates the need to write multiple confidential recommendations of the same individual when the individual applies to multiple institutions by enabling the recommender to distribute multiple links to the same confidential recommendation. The system also enables the recommender to easily edit the recommendation at any time before or after multiple links have been distributed, thereby ensuring that the recommender retains control over the content of the confidential recommendation.

A general aspect of the invention is a website for helping a recommender to provide confidential recommendations for individuals. The website includes: a recommendation creation capability for use by a recommender for enabling the recommender to create a confidential recommendation; a recommendation link creation capability for use by the recommender for enabling the recommender to create the link to the confidential recommendation; and a recommendation link control capability for use by the recommender for controlling the link to the confidential recommendation.

In some embodiments, the website further includes: a recommendation creation request capability for use by an individual for sending to a recommender a request to create the confidential recommendation.

In some embodiments, the website further includes: a recommendation forward request capability for use by an individual for sending a request to the recommender to forward a link to the content of the confidential recommendation to a third party.

In some embodiments, the website further includes: a recommendation link sending capability for use by the recommender for sending the link to the confidential recommendation to the third party.

In some embodiments, the recommendation creation capability for use by a recommender for enabling the recommender to create the confidential recommendation includes an upload capability for uploading the confidential recommendation to the website.

In some embodiments, the recommendation link control capability for use by the recommender for controlling the link to the confidential recommendation includes a capability for at least one of: changing the link expiration date; changing the content pointed to by the link; temporarily suspending a link; re-activating a link; and deleting a link.

In some embodiments, the website further includes: a recommendation link actuating capability for use by the third party for actuating the link so as to display the confidential recommendation.

Another general aspect of the invention is a website for helping a recommender to provide confidential recommendations for individuals. The website includes: a recommendation creation capability for use by a recommender for enabling the recommender to create a confidential recommendation; a recommendation link creation capability for use by the recommender for enabling the recommender to create the link to the confidential recommendation; and a recommendation link control capability for use by the recommender for controlling the link to the confidential recommendation, the recommendation link control capability including a capability for at least one of: changing the link expiration date; changing the content pointed to by the link; temporarily suspending a link; re-activating a link; and deleting a link.

In some embodiments, the website further includes: a recommendation creation request capability for use by an individual for sending to a recommender a request to create the confidential recommendation.

In some embodiments, the website further includes: a recommendation forward request capability for use by an individual for sending a request to the recommender to forward a link to the content of the confidential recommendation to a third party.

In some embodiments, the website further includes: a recommendation link sending capability for use by the recommender for sending the link to the confidential recommendation to the third party.

In some embodiments, the recommendation creation capability for use by a recommender for enabling the recommender to create the confidential recommendation includes an upload capability for uploading the confidential recommendation to the website.

In some embodiments, the website further includes: a recommendation link actuating capability for use by the third party for actuating the link so as to display the confidential recommendation.

Another general aspect of the invention is a method for helping a recommender to provide confidential recommendations for individuals. The method includes: providing a recommendation creation capability for use by a recommender for enabling the recommender to create a confidential recommendation; providing a recommendation link creation capability for use by the recommender for enabling the recommender to create the link to the confidential recommendation; and providing a recommendation link control capability for use by the recommender for controlling the link to the confidential recommendation.

In some embodiments, the website further includes: providing a recommendation creation request capability for use by an individual for sending to a recommender a request to create the confidential recommendation.

In some embodiments, the website further includes: providing a recommendation forward request capability for use by an individual for sending a request to the recommender to forward a link to the content of the confidential recommendation to a third party.

In some embodiments, the website further includes: providing a recommendation link sending capability for use by the recommender for sending the link to the confidential recommendation to the third party.

In some embodiments, providing the recommendation creation capability for use by a recommender for enabling the recommender to create the confidential recommendation includes providing an upload capability for uploading the confidential recommendation to the website.

In some embodiments, providing the recommendation link control capability for use by the recommender for controlling the link to the confidential recommendation includes providing a capability for at least one of: changing the link expiration date; changing the content pointed to by the link; temporarily suspending a link; re-activating a link; and deleting a link.

In some embodiments, the website further includes: providing a recommendation link actuating capability for use by the third party for actuating the link so as to display the confidential recommendation.

### BRIEF DESCRIPTION OF THE DRAWINGS

The invention will be more fully understood from the following detailed description, in conjunction with the following figures, wherein:

FIG. 1 is a top-level schematic overview of a system showing the general interaction via the internet between an anonymous individual and a website, and between a potential employer and the website, so as to enable the potential employer to discover a desirable individual based on the individual's anonymous profile maintained by the website.

FIG. 2 is a detailed schematic view of the system of FIG. 1, showing some modules of the website, and their interaction with the anonymous individual and the potential employer.

FIG. 3 is a detailed schematic view of the system of FIG. 2, further showing a connection manager and a connection repository.

FIG. 4 is a top-level schematic overview of a system showing the general interaction via the internet between a website and an anonymous individual that is anonymous to a potential employer, and between the website and a recommender, and between the website and a potential employer, and between the website and an other third party. The system enables the recommender to write for the individual either a regular recommendation or a confidential recommendation. The system also enables the individual to include the regular recommendation in the anonymous profile so as to enable the potential employer or to the other third party to view the regular recommendation as part of the anonymous profile. The system also enables the individual to ask the recommender to forward a link to a confidential recommendation to the potential employer or to the other third party. The system also enables the recommender to forward the link to the confidential recommendation to the potential employer or to the other third party.

FIG. 5 is a detailed schematic view of the system of FIG. 4, showing the website modules and their interaction with anonymous individuals and potential recommenders, so as to create and manage either regular recommendations or confidential recommendations, and so as to enable inclusion of the regular recommendations in the public profile of the anonymous individuals.

FIG. 6 is a detailed schematic view of the system of FIG. 4, showing the website modules and their interaction with an anonymous individual asking a recommender to forward a previously written confidential recommendation to a potential employer or to an other third party in a non-anonymous way. Also shown are the website modules that enable the recommender to forward the confidential recommendation to the potential employer or to an other third party.

FIG. 7 is a web page view showing a top portion of the anonymous profile including the Summary section having a Personal summary heading, and including the Categories section having three different category headings.

FIG. 8 is a web page view showing a bottom portion of the anonymous profile including the My Custom Categories section having six different custom category headings.

FIG. 9 is a web page view showing a top portion of the anonymous profile including the Summary section having a Personal summary heading, further showing the content of the Personal Summary section.

FIG. 10 is a web page view showing a top portion of the anonymous profile including the Summary section having a Personal summary heading, further showing the edit view of the content of the Personal Summary section.

FIG. 11 is a web page view of the contact form used by a potential employer to contact an anonymous individual.

FIG. 12 is a web page view of a Message Box showing all sent and received messages, message dates, message subjects and relevant commands.

FIG. 13 is a web page view of a Connections list showing all connections to and from the anonymous individual, each connection including either the name or the nickname of the connected party and associated information.

FIG. 14 is a web page view of a Search page used for finding anonymous individuals based on search criteria, also showing a Search Results list of nicknames of anonymous individuals matching the search criteria.

FIG. 15 is a web page view of the New Recommendation Request form used by an anonymous individual known to a potential recommender to ask the potential recommender to write a recommendation.

FIG. 16 is a web page view of the Write a Recommendation form used by the recommender to write a recommendation for a anonymous individual known to the recommender.

FIG. 17 is a web page view of the My Recommendations page showing all recommendations received by the anonymous individual.

FIG. 18 is a web page view of the anonymous profile of an anonymous individual, showing the recommendations that the anonymous individual chose to make public.

FIG. 19 is a web page view of the Recommended by Me page showing all recommendations written by the anonymous individual that is logged in to the system.

FIG. 20 is a web page view of a Links to a CONFIDENTIAL Recommendation page showing all links to a specific confidential recommendation written for a known anonymous individual by the recommender that is logged in to the system.

FIG. 21 is a web page view of a Recommendation Requests page showing two sections: an “Others asked me to recommend them” section having a list of all recommendation requests from other anonymous individuals known to the anonymous individual that is logged into the system, the other anonymous individuals asking for a recommendation. Also shown is an “I asked others to recommend me” section having a list of all recommendation requests by the anonymous individual that is logged into the system, asking a recommender to recommend the anonymous individual that is logged in to the system.

### DETAILED DESCRIPTION

The system is an online service, website, or method that provides a way for an individual seeking employment or business opportunities to create an anonymous public posting of information about that individual. The system empowers the individual to express what he believes to be his true self, while preserving his anonymity. The self-expressed description of an individual is stored in an anonymous profile and can be supplemented by recommendations from others. The system helps individuals to comprehensively express their true self, including information relating to education, experiences, skills, and general personality characteristics, while remaining anonymous. The anonymous nature of the posting of information enabled by the system is intended to encourage full disclosure, and to eliminate concerns of being identified by anyone such as friends, colleagues, employers, or potential employers.

An anonymous individual is represented by a combination of what the individual writes in the anonymous profile, and recommendations received from others. The self-description of an individual represents what an individual believes about himself, while the recommendations represent what others believe about the individual.

The system enables two types of recommendations: regular recommendations and confidential recommendations. Regular recommendations are included in each individual's public anonymous profile, unless the individual chooses to exclude them. Confidential Recommendations are hidden from the recommended individual, so that the recommended individual is not able to see the content of Confidential Recommendation. An individual can review the content of a regular recommendation and decide whether to include the regular recommendation in the recommended individual's anonymous profile. The recommended Individual has no control over confidential recommendations and cannot see the content of a Confidential Recommendation. Confidential recommendations always remain under complete control of the recommender. All an individual can do is ask the recommender to send to a third party a link that points to a confidential recommendation. It is up to the recommender to decide whether to send such a link to a third party, and for how long the link to a Confidential Recommendation will remain active.

The system also provides search tools for potential employers seeking unique individuals. Individuals remain anonymous while potential employers are offered an opportunity to convince an anonymous individual to communicate. The anonymous individual is in full control, can block further contact attempts from any specific searcher, and always remains anonymous.

The system includes:
1. A Profile Manager and a Profile Repository that contains anonymous individual profiles.
2. A Communications Manager that along with a Message Repository enables communications between potential employers and anonymous individuals, while preserving the individual's anonymity.
3. A Search Manager that enables Potential Employers to search for anonymous individuals that match their search criteria, while preserving the individuals' anonymity.
4. A Connection Manager that along with a Connection Repository enables the anonymous individual to control communications and prevent future contact from undesired potential employers.
5. A Recommendations Manager that utilizes a Recommendations Repository and establishes, along with the Profile Manager, a comprehensive representation of an individual. The comprehensive representation of the individual includes the anonymous profile containing anonymous information that an individual presents about himself, and recommendations that represent what others are saying about the anonymous individual.
6. Links Manager and Links Repository that enable a recommender to share confidential recommendations with other third parties, while never sharing confidential recommendations with the recommended individual.
7. A business model that discourages undesired communications by charging a fee for establishing a connection with an anonymous individual.

Unlike conventional employment boards where employment candidates list their resumes for potential and often anonymous employers to consider, our individual profiles are anonymous while potential employers are identified. It is the potential employer's responsibility to convince an anonymous individual that the potential employer is worth engaging in communication.

Individuals remain anonymous during all stages and can discontinue communications at will. The system discourages unwarranted communications, general announcements and spam by charging a communications fee for contacting new individuals.

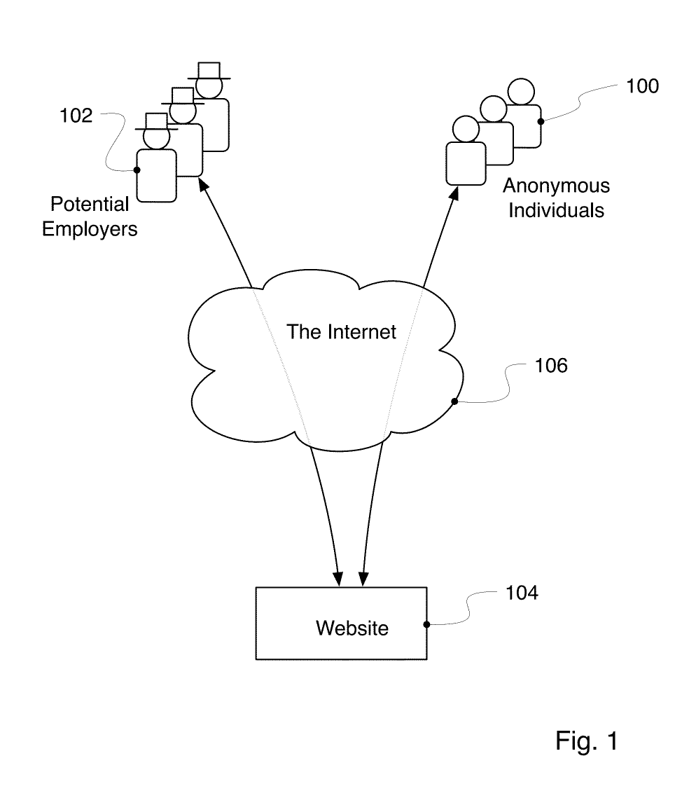

With reference to FIG. 1, this is a top-level overview of the system showing the general interaction between anonymous individuals 100, potential employers 102, a website 104, and the Internet 106. Anonymous individuals 100 and potential employers 102 connect to a website 104 over the Internet 106. There is never a direct interaction between potential employers 102 searching for talent and anonymous individuals 100. All communications are facilitated by the website 104 over the Internet 106.

The individual 100 creates and maintains an anonymous profile on website 104. Potential employers 102 search the anonymous profiles in the website 104 and utilize the website 104 to communicate with anonymous individuals 100. Individuals 100 always remain anonymous to the potential employers 102.

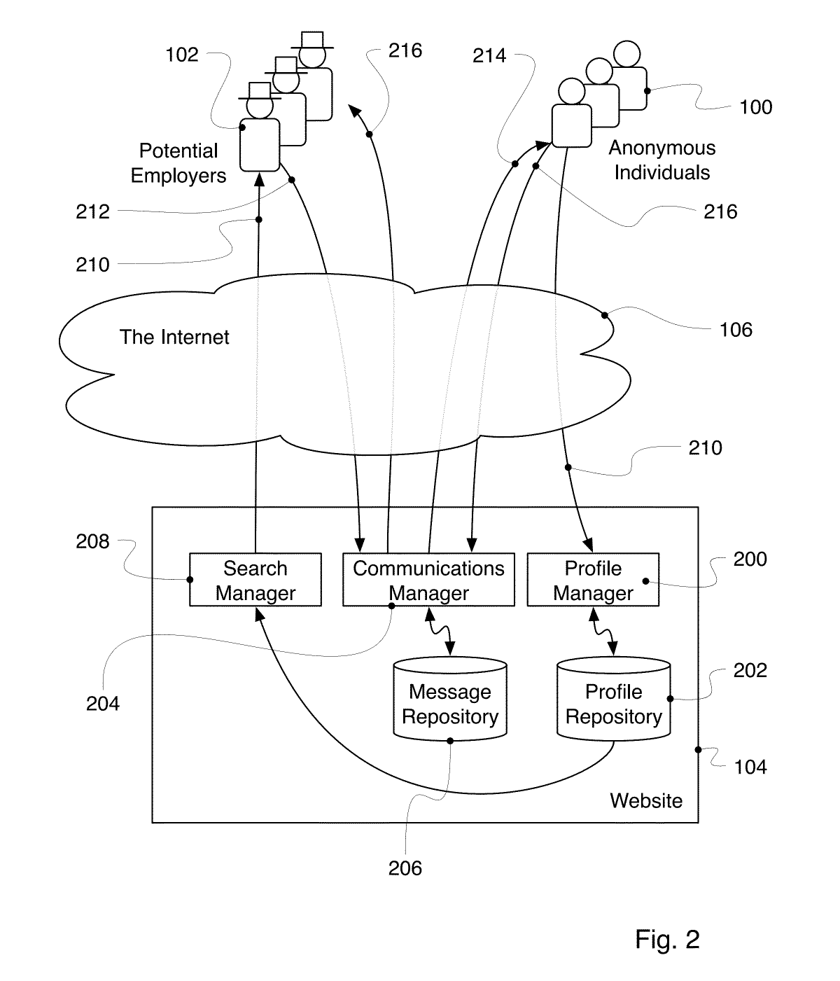

With reference to FIG. 2, this is a detailed view of the system, showing the website 104, profile manager 200, profile repository 202, communications manager 204, message repository 206, and search manager 208 as part of the website 104. Anonymous individuals 100 and potential employers 102 communicate with the website 104 over the Internet 106.

Anonymous individuals 100 create and submit their anonymous profile 210 to the profile manager 200. Profile manager 200 deposits profiles 210 into profile repository 202.

Potential employers 102 utilize search manager 208 to find anonymous individuals with whom they might want to communicate. Potential employers 102 retrieve anonymous profiles 210 of individuals 100 matching their search criteria, as submitted to search manager 208, and review the profiles 210 to further decide which individuals 100 the potential employer 102 would like to communicate with.

When potential employers 102 decide to communicate with a chosen anonymous individual 100, the potential employers 102 submit a message 212 to the communications manager 204 with a reference to the anonymous profile 210 belonging to the anonymous individual 100 for whom the message is intended. Communications manager 204 stores the message 212 in message repository 206, and sends an email to the anonymous individual 100. The email contains identifying information of the potential employer and a standard html link 214 pointing to a webpage that can display the message 212, if the anonymous individual 100 properly authenticates by providing proper credentials, such as username and password.

The anonymous individual 100 can view the message by clicking on link 214. If the anonymous individual 100 decides to send a reply 216 to the potential employer 102, he can use the communications manager 204 to do so without ever disclosing his identity or email address, as the reply 216 will be delivered to the potential employer 102 from communications manager 206, and not from the anonymous individual's 100 email address.

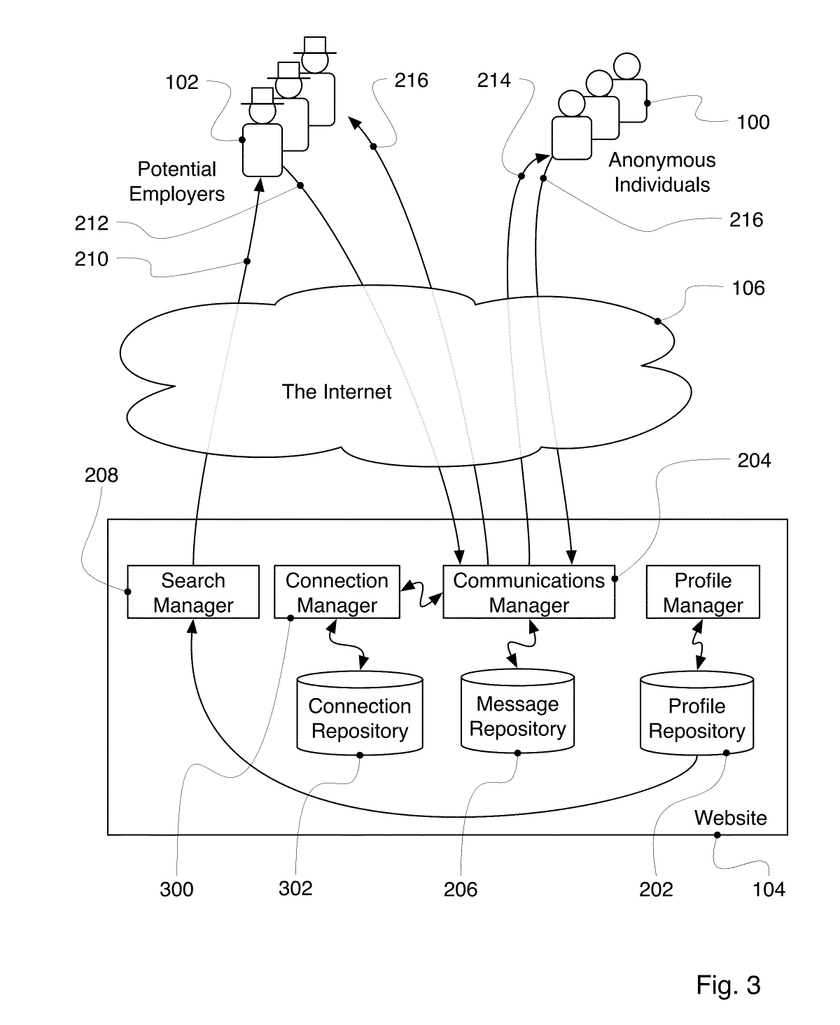

With reference to FIG. 3, this is a detailed view of the system from FIG. 2, further showing a connection manager 300 and a connection repository 302. The connection manager 300 manages all connections between potential employers 102 and anonymous individuals 100. The connection manager 300 keeps all connection data in connection repository 302.

The semi-anonymous communications process 210, 212, 214, 216, where the potential employer 102 is identified while the individual 100 remains anonymous, can continue as long as both sides desire. The anonymous individual 100 has the ability to block all additional messages from a specific potential employer 102. Such block can be permanent, or be for a time limit, and is managed by connection manager 300. A block with a time limit will automatically expire at a preset time and the potential employer 102 will again be able to communicate with this specific anonymous individual 100. At anytime, the anonymous individual 100 can instruct the connection manager 300 to remove any block, regardless of the existence or expiration of a time limit.

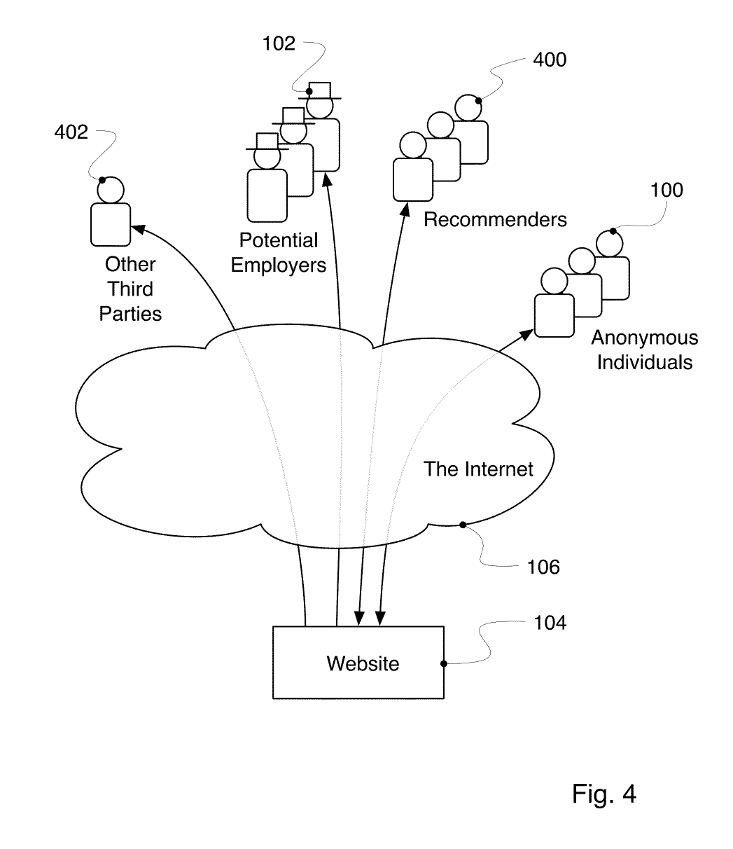

With reference to FIG. 4, this is a top-level schematic overview of a system showing the general interaction via the internet 106 between the anonymous individual 100 and the website 104, and between a recommender 400 and the 104 website, and between the potential employer 102 and the website 104, and between an other third party 402 and the website 104, so as to enable the individual 100 to identify himself to a potential recommender 400, and so as to enable the recommender 400 to write either a regular recommendation or a confidential recommendation for the identified individual 100, and so as to enable the individual 100 to forward the regular recommendation to the potential employer 102 or the other third party 402, or to enable the individual to request the recommender 400 to forward a link to a confidential recommendation to the potential employer 102 or to the other third party 402, and then to enable the recommender to forward the link to the confidential recommendation to the potential employer 102 or the other third party 402.

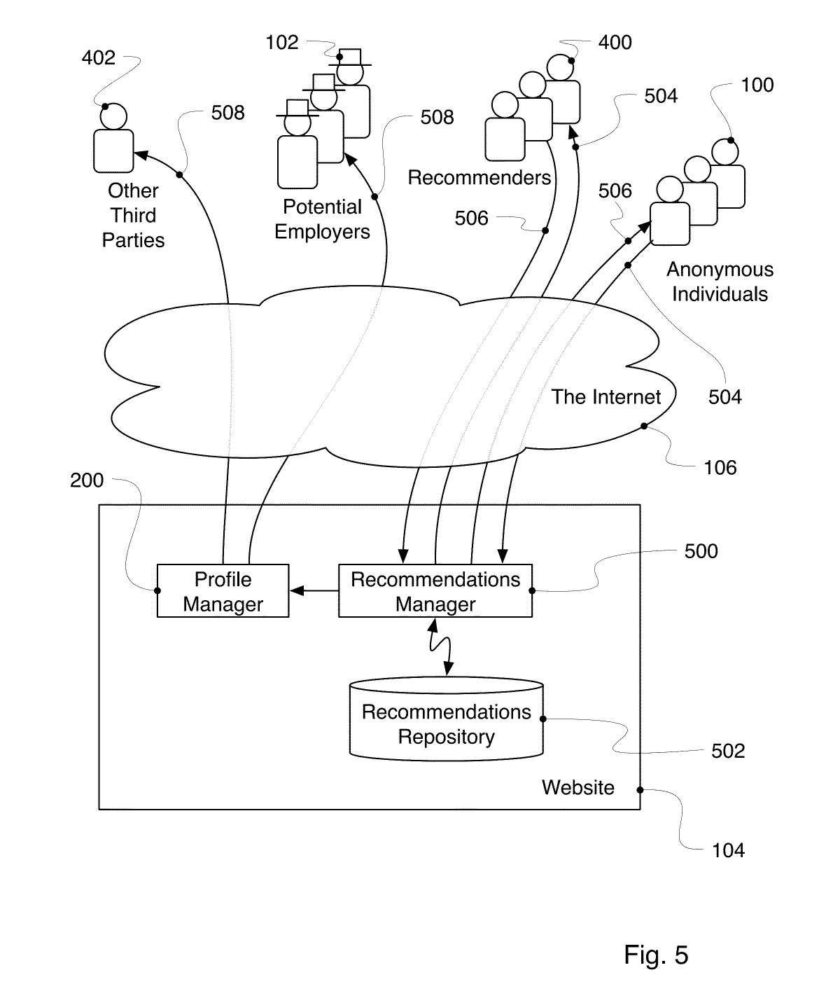

With reference to FIG. 5, this is a detailed view of the system, showing the website 104, profile manager 200, recommendations manager 500, recommendations repository 502 and their interaction with anonymous individuals 100, recommenders 400, potential employers 102, and other third parties 402 when creating regular or confidential recommendations.

The individual 100 sends a non-anonymous recommendation request 504 to a potential recommender 400, via recommendations manager 500. The recommendation request 504 specifies whether the recommended individual is interested in a regular or a confidential recommendation. Recommendations manager 500 verifies that the potential recommender 400 has an anonymous profile and forwards the recommendation request 504 to the recommender 400. If the potential recommender 400 does not have an anonymous profile in the system, he will be asked to create one. The individual 100 requesting a recommendation has to include his identifying information in the recommendation request 504.

Potential recommender 400 writes a recommendation 506 and submits it to the recommendations manager 500 over the Internet 106. Recommendations manager 500 stores the recommendation 506 in recommendations repository 502. If this is a regular recommendation, then the recommendations manager 500 enables the recommended individual 100 to view the content of the regular recommendation 506 as stored in the recommendation repository 502. The recommendations manager 500 does not enable the recommended individual to view the contents of confidential recommendations. The recommended individual 100 has no access to the content of confidential recommendations.

The recommended individual 100 utilizes the profile manager 200 to include or exclude each regular recommendation in his public profile. Regular recommendations that are included in the public profile 508 can be viewed by potential employers and other third parties.

A recommendation is created by a recommender 400 and is stored in the recommendations repository 500. Recommendation content remains under the exclusive control of the recommender 400 at all times, thus the recommender 400 can utilize recommendations manager 500 to update, at any time, the contents of any recommendation that the recommender 400 wrote. If the recommendation is a regular (non-confidential) recommendation, then the recommended individual 100 can choose to include that regular recommendation along with the recommended individual's public profile. If the recommendation is a confidential recommendation, then the recommended individual 100 has no access to it at all. However, the recommended individual 100 can ask the recommender 400 to forward a link to the confidential recommendation to a potential employer 102, or to an other third party 402.

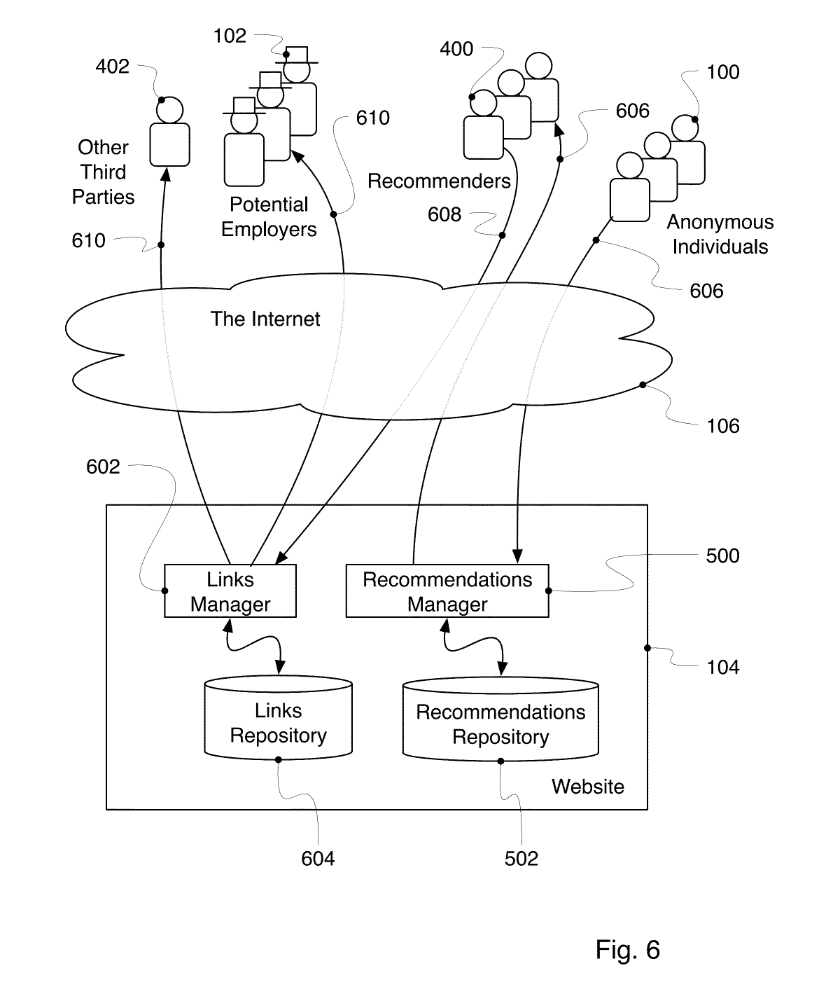

With reference to FIG. 6, this is a detailed view of the system, showing the website 104, recommendations manager 500, recommendations repository 502, links manager 602, links repository 604, anonymous individuals 100, recommenders 400, potential employers 102, the other third party 402, and showing the process of sending a link to the content of a confidential recommendation 610 to the potential employer 102 or the other third party 402.

Anonymous individual 100 utilizes recommendations manager 500 to create a request 606 to forward the content of a specific confidential recommendation to the potential employer 102 or to the third party 402. The anonymous individual 100 has no way of knowing the actual contents of the confidential recommendation he is asking to forward.

Recommendations manager 500 forwards the request 606 to forward a confidential recommendation to the recommender 400. The recommender 400, at his discretion, utilizes the link manager 602 to create a link to a confidential recommendation 608. The links manager 602 records the link information in the links repository 604 so that the link can later be interpreted by the website 104, and the content of the appropriate confidential recommendation displayed. The recommender 400 utilizes the links manager 602 to send the link 610 to the confidential recommendation to the potential employer 102 or to the third party 402.

The recommender 400 can utilize recommendations manager 500 to update the content of the confidential recommendation he wrote at any time, before or after sending a link 610 to the potential employer 102 or to the other third party 402.

The link to a confidential recommendation 610 can be valid forever, or can have an expiration date. Any link to a confidential recommendation 610 that has an expiration date can only be used prior to such expiration date. The recommender 400 can change the expiration date at any time, before or after sending the link 610 to a confidential recommendation to the potential employer 102 or to the other third party 402.

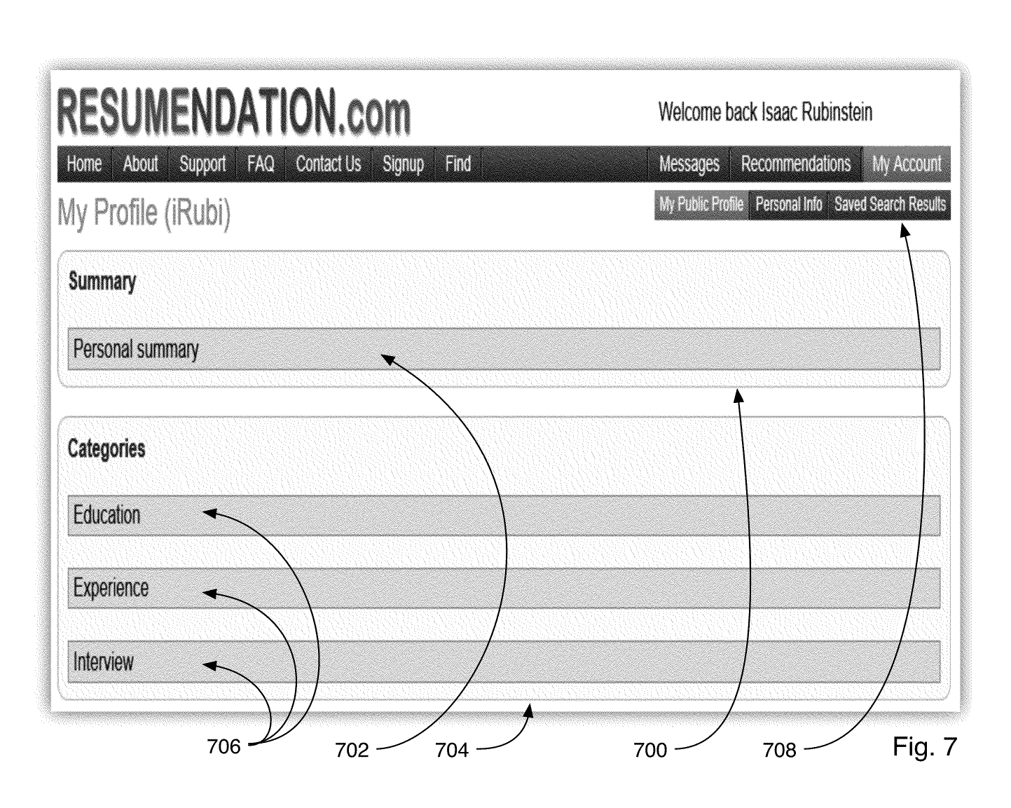

With reference to FIG. 7, this is a web page view showing a top portion of the anonymous profile including the Summary section 700 having a Personal summary heading 702, and including the Categories section 704 having three different category headings 706: Education, Experience, and Interview. Clicking on any of the section headers 700 or 706 will expose content associated therewith and enable editing of the content.

The Education section contains the institution, department, degree and year completed for each education experience.

The Experience section contains a title and associated free-form text for each experience of any type that the anonymous individual desires to include in the public profile.

The Interview section contains a question and associated free-form answer text for each question that the anonymous individual desires to include in the public profile.

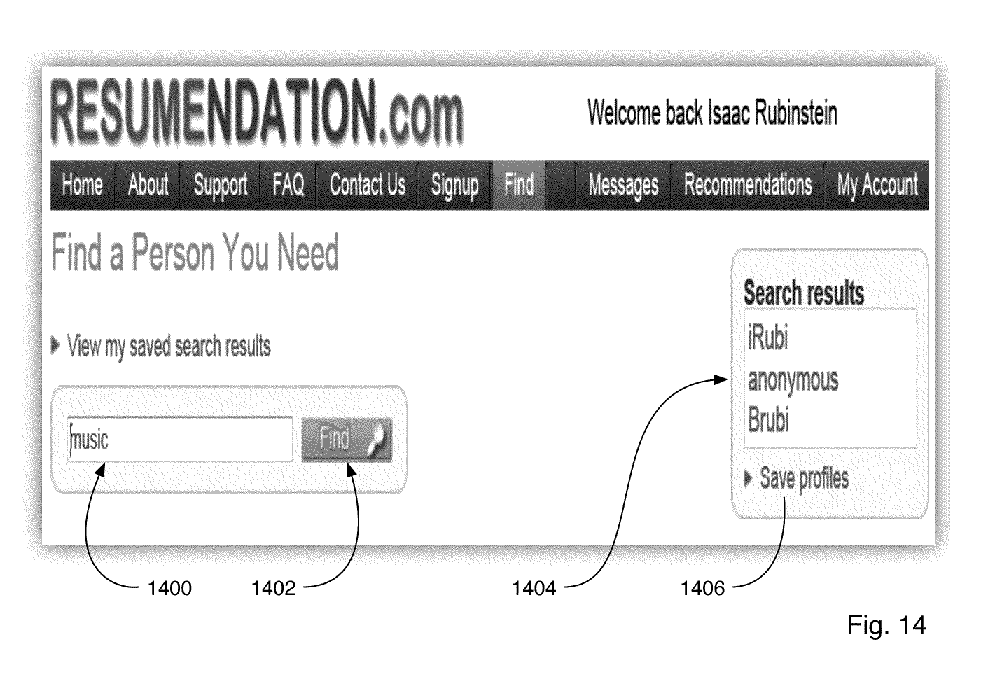

Save Search Results menu option 708 is used to access a list of all saved search results, as further described in FIG. 14.

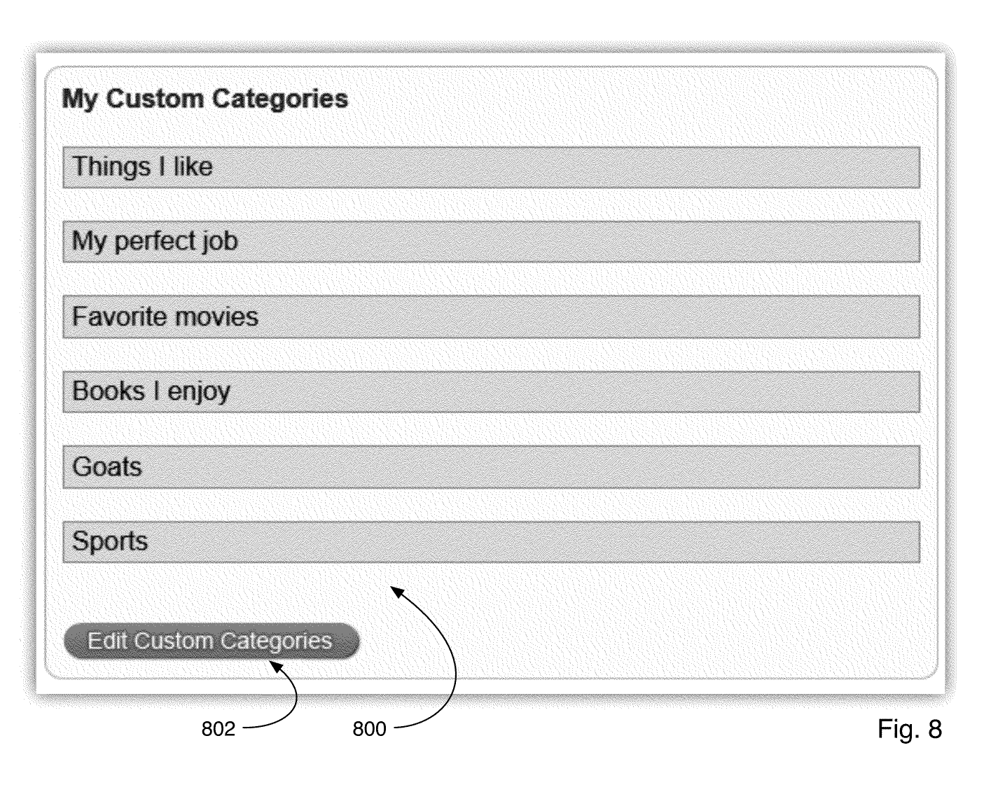

With reference to FIG. 8, this is a web page view showing a bottom portion of the anonymous profile including the My Custom Categories section having a plurality of different custom category headings 800. The number of custom category headers is determined by the number of custom categories created by the user (i.e. the anonymous individual). To create a new custom category, or to edit an existing custom category, the user clicks on the Edit Custom Categories button 802. Each custom category has a category header and an associated free-form text.

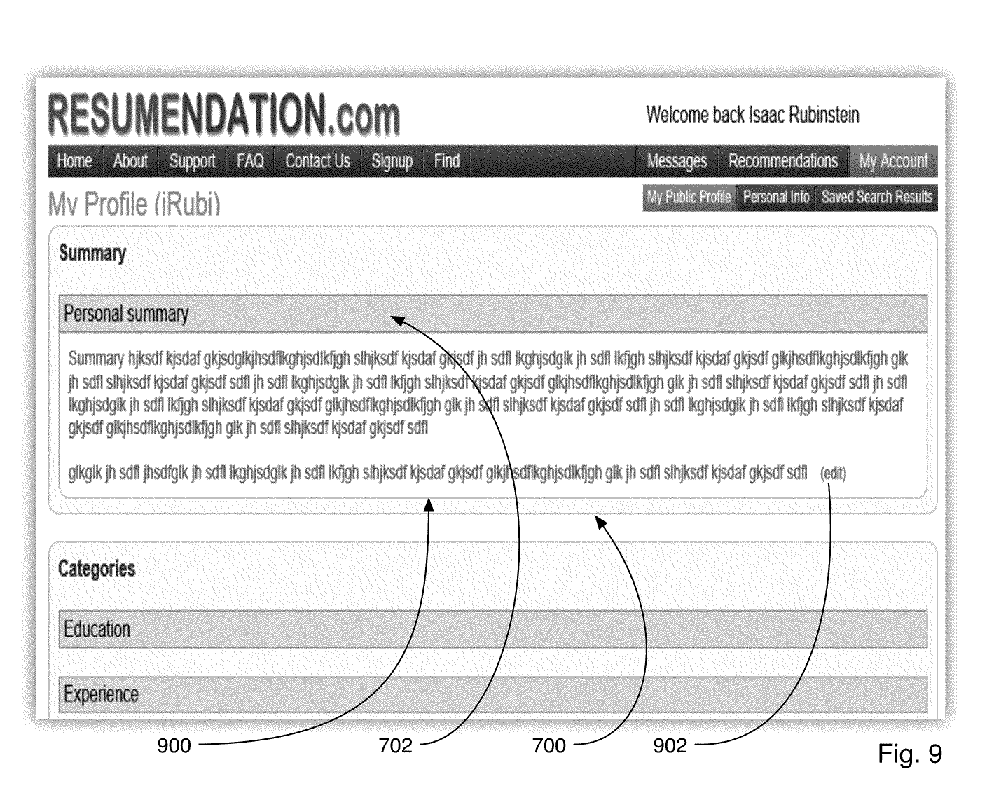

With reference to FIG. 9, this is a web page view showing a top portion of the anonymous profile, including the Summary section 700 having a Personal summary heading 702, further showing the content 900 of the Personal summary heading 702. To edit the content 900 of the Personal summary heading 702, the user clicks on the edit link button 902.

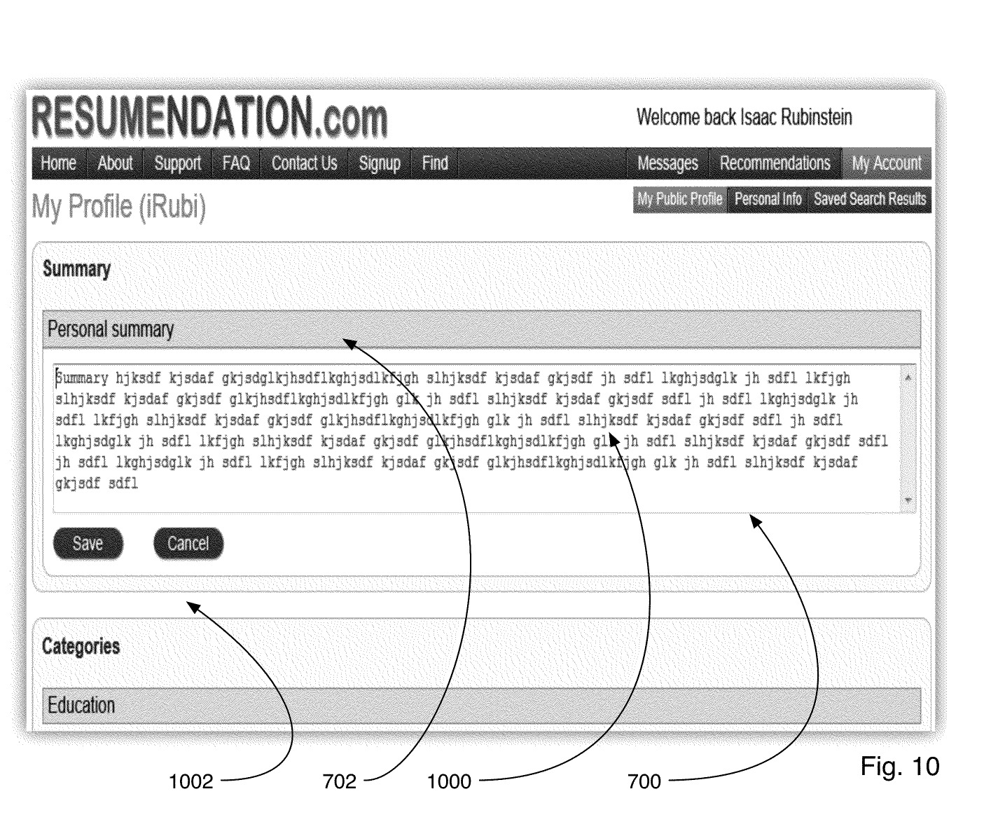

With reference to FIG. 10, this is a web page view showing a top portion of the anonymous profile including the Summary section 700 having a Personal summary heading 702, further showing the edit view of the content 1000 of the Personal Summary section 700. Save and Cancel buttons 1002 will save or cancel the latest edits.

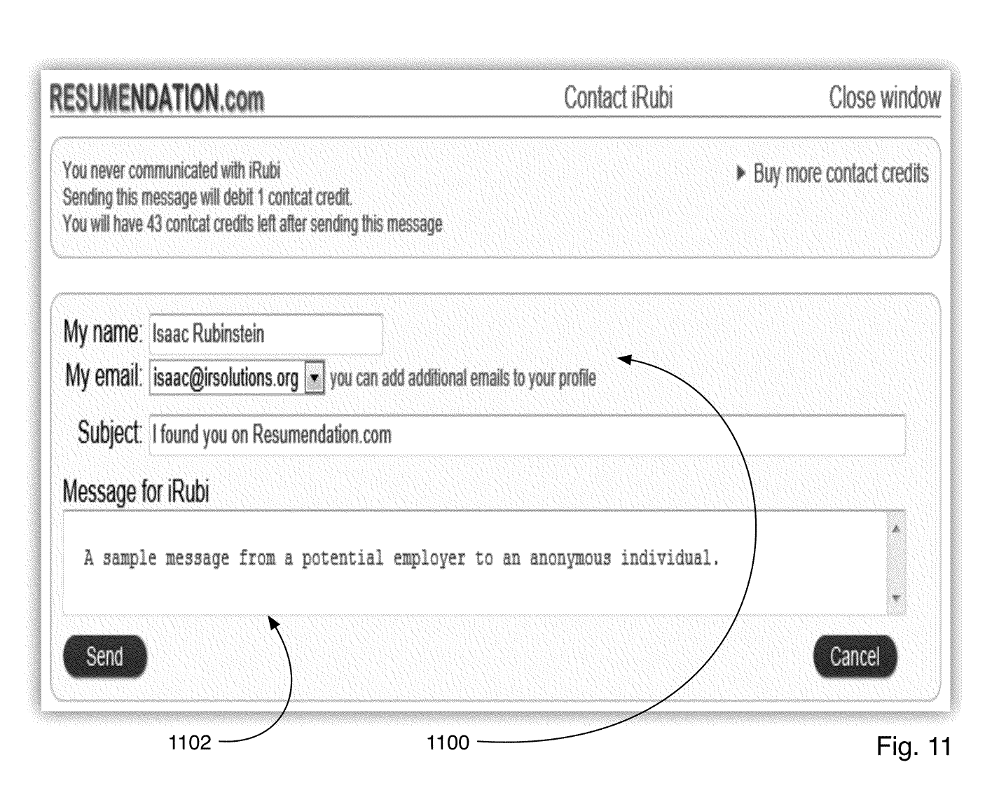

With reference to FIG. 11, this is a web page view of the contact form used by a potential employer 102 to contact an anonymous individual 100. The contact form includes identifying information 1100 about the potential employer 102. The identifying information 1100 can include a name, and one of the potential employer's 102 email addresses. The contact form also includes a message 1102, which can also include a Subject line.

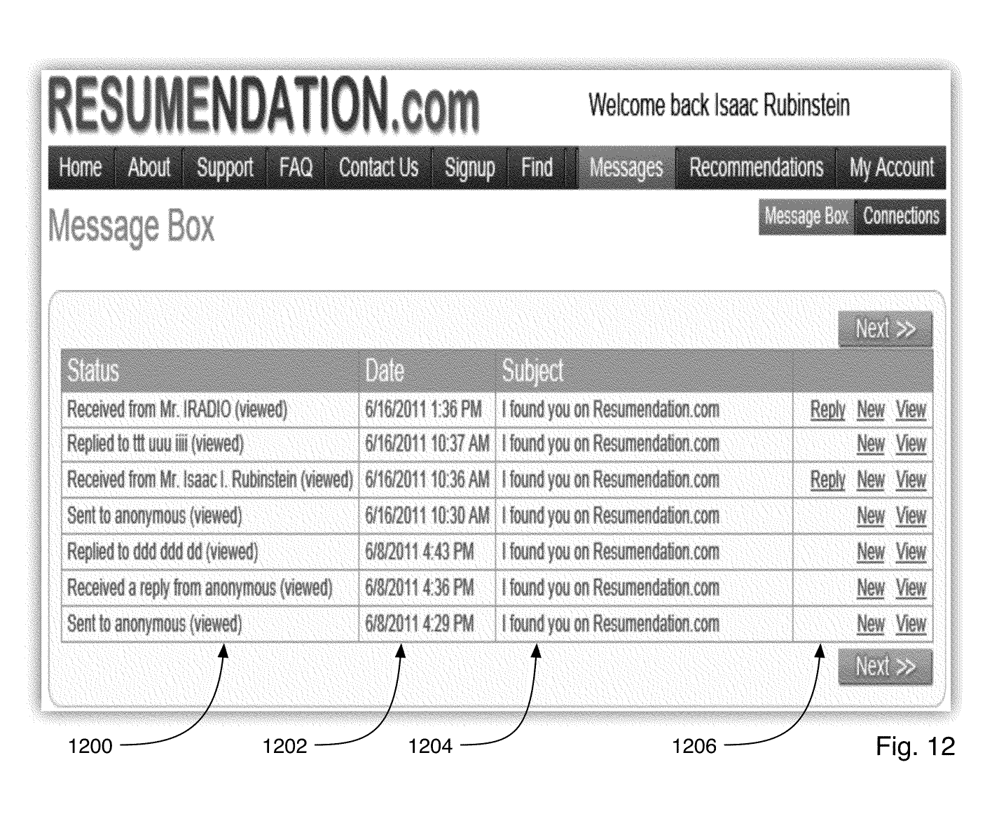

With reference to FIG. 12, this is a web page view of a Message Box page, the message box is capable of containing a plurality of sent messages and plurality of received messages. Each message is shown in a grid by a row containing a status 1200, a date 1202, a subject 1204, and respective relevant commands 1206.

For two parties to communicate between each other, there must be a connection. Only an employer can create a connection, and the employer must pay to create the connection. Once a connection is created, it can be used at any time by either the employer or the anonymous individual. Both the potential employer and the anonymous individual can initiate a new message within a connection, or can reply to an existing message.

When an employer sends a message, in the receiver's Message Box, the Status 1200 of the message includes the real name of the employer, and an indication of whether the message was unopened or viewed. The Date 1202 of the message indicates the date that the message was sent. The Subject 1204 indicates the subject of the message. The relevant commands 1206 includes the options Reply, New, and View. Clicking on Reply enables the user to reply to the message from the potential employer 102. The potential employer 102 receiving such a reply will see only a nickname representing the anonymous individual 100, along with the status (viewed or unopened). The commands available to the potential employer 102 in a message that is a reply from an anonymous individual 100 are: New and View. Thus, it is not possible to reply to a reply with a reply message. Instead, one must initiate a new message if further communication is desired after a reply to a message is received. The same message in the sender's Message Box appears with the nickname of the anonymous individual 100 in the Status field 1200, and the Reply command will not be included.

When the anonymous individual 100 replies to the message, the reply message appears in the anonymous individual's Message Box with the potential employer's real name in the Status field, and only New and View commands are available. The same reply message will appear in the Message Box of the potential employer 102 (the recipient of the reply message) with the nickname of the anonymous individual 100 and all three commands Reply, New, and View are available.

An anonymous individual 100 can also initiate a message to a potential employer 102 by clicking on the New command of a message in the Message Box from that potential employer. An anonymous individual can communicate only with those potential employers 102 that have created a connection by paying a fee to send messages to the anonymous individual 100.

A person can assume the role of either a potential employer 102, or an anonymous individual 100. Thus, a Message Box of a person can include messages from both anonymous individuals 100 and from potential employers 102. Consequently, the Message Box can also include messages representing replies to messages from both potential employers 102 and anonymous individuals 100. Thus, there are four types of messages. Any message received from an anonymous individual 100 will include a nickname of the anonymous individual 100, and any message received from a potential employer 102 will include the real name of the potential employer 102, regardless of whether the message is a new message, or a reply message. Any message sent to an anonymous individual 100 will include a real name of a potential employer 102, and any message sent to a potential employer 102 will include the nickname of the anonymous individual 100, regardless of whether the message is a new message, or a reply message.

Any new message will include a Reply command when seen in the recipient's Message Box. That same new message when seen in the sender's Message Box will NOT include a Reply command.

Any reply message will NOT include a Reply command, regardless of the owner of the Message Box, because it is not possible to reply to a reply message.

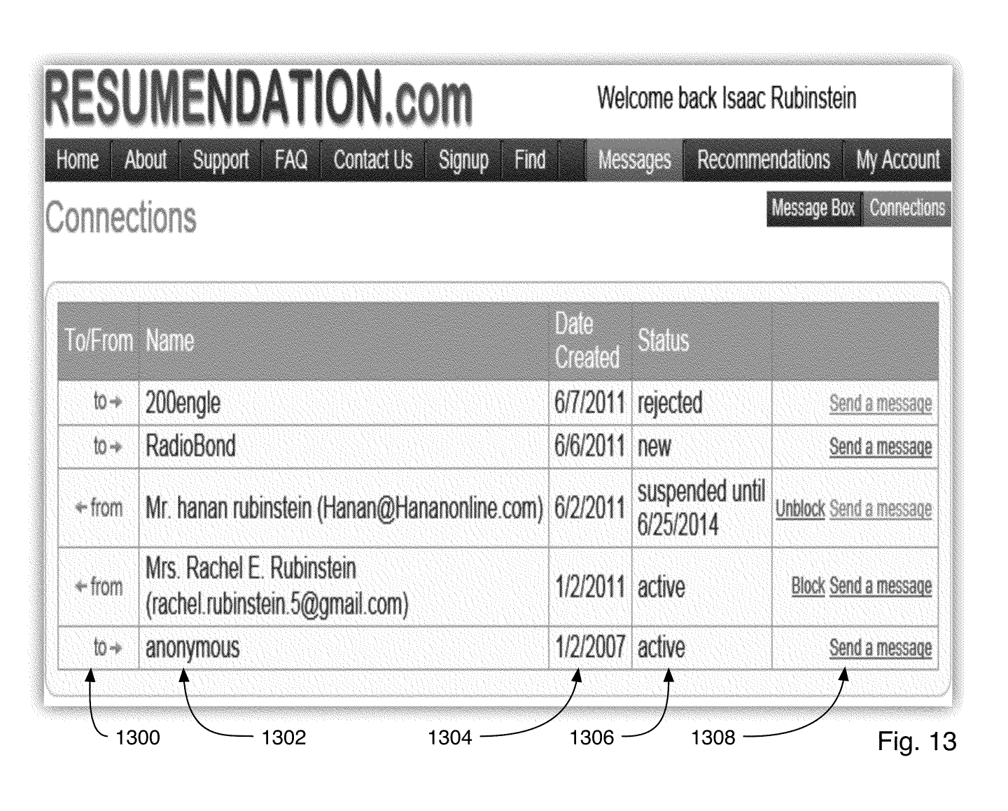

With reference to FIG. 13, this is a web page view of a Connections list showing all connections to and from the anonymous individual, each connection including either the name or the nickname of the connected party and associated information, to be described below.

To/From column 1300 indicates the originator of the connection. Any connection initiated and paid for by the user to communicate with an anonymous individual 100 means that the user is acting as a potential employer 102 with regards to this connection. Such a connection will be indicated by “to” and the Name column 1302 will include the nickname of the anonymous individual 100. The command column 1308 includes an active “Send a message” command if the connection is open, or a disabled “Send a message” command if the connection is either rejected by the anonymous individual 100, or if the connection is temporarily suspended by the anonymous individual 100.

Any connection not initiated and therefore not paid for by the user indicates that with regards to this connection, the user is acting as a anonymous individual 100. Such a connection is indicated by “from” in the To/From column 1300, and the Name column 1302 of the connection contains the actual name and email address of the potential employer 102. The command column 1308 includes commands Block, Unblock, and “Send a message”. The “Send a message” command is disabled whenever the connection is blocked.

The date column 1304 will always include the date that a connection was initiated.

The status column 1306 indicates the status of the connection, and can include “new”, “active”, “rejected”, or “suspended until” along with a date indicating when the suspension ends.

With reference to FIG. 14, this is a web page view of a Search page used for finding anonymous individuals 100 based on search criteria 1400, also showing a Search Results list 1404 of nicknames of anonymous individuals 100 matching the search criteria 1400.

When a potential employer 102 enters the search criteria 1400 and clicks on a Find button 1402, the Search results list 1404 is populated with a list of nicknames belonging to all anonymous individuals 100 whose anonymous profiles match the search criteria 1400. Clicking on Save profiles 1406 saves the search results list 1404 for later use.

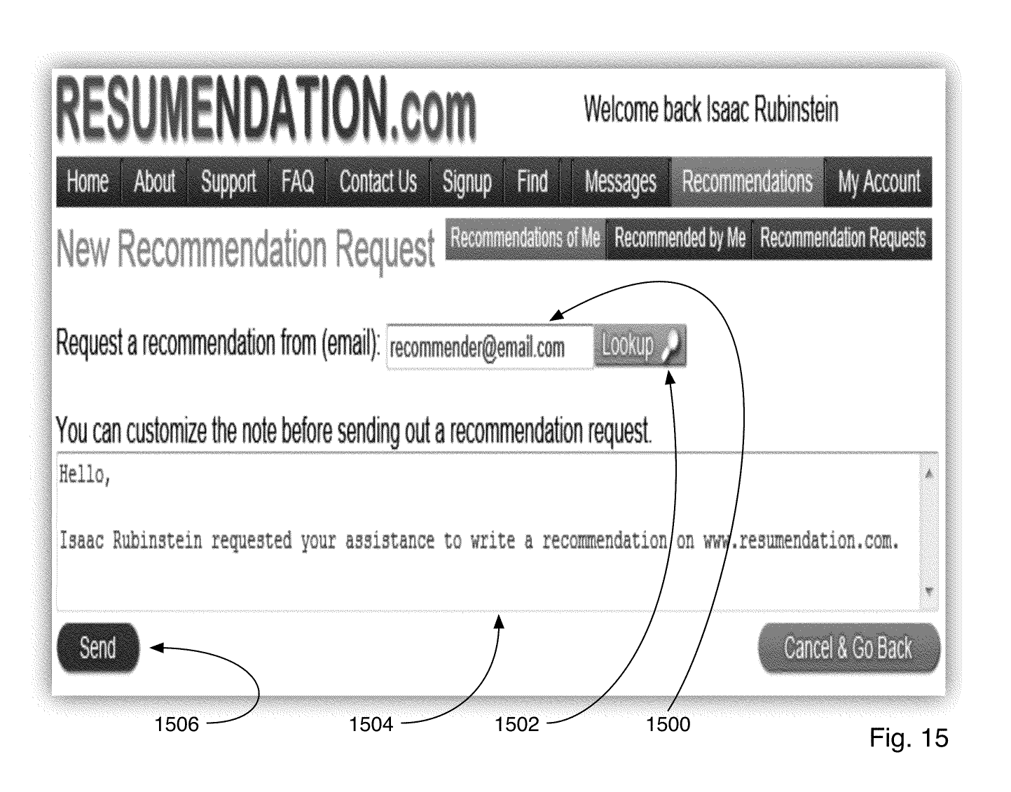

With reference to FIG. 15, this is a web page view of the New Recommendation Request form used by an anonymous individual 100 known to a potential recommender 400 to ask the potential recommender 400 to write a recommendation for the requesting anonymous individual 100, the recommended anonymous individual 100 not being anonymous to the recommender.

The recommender 400 is designated by entering the recommender's email address 1500 and clicking on the Lookup button 1502. The requesting party 100 can enter a text message 1504 to the recommender 400. Clicking the Send button 1506 sends the recommendation request to the recommender 400.

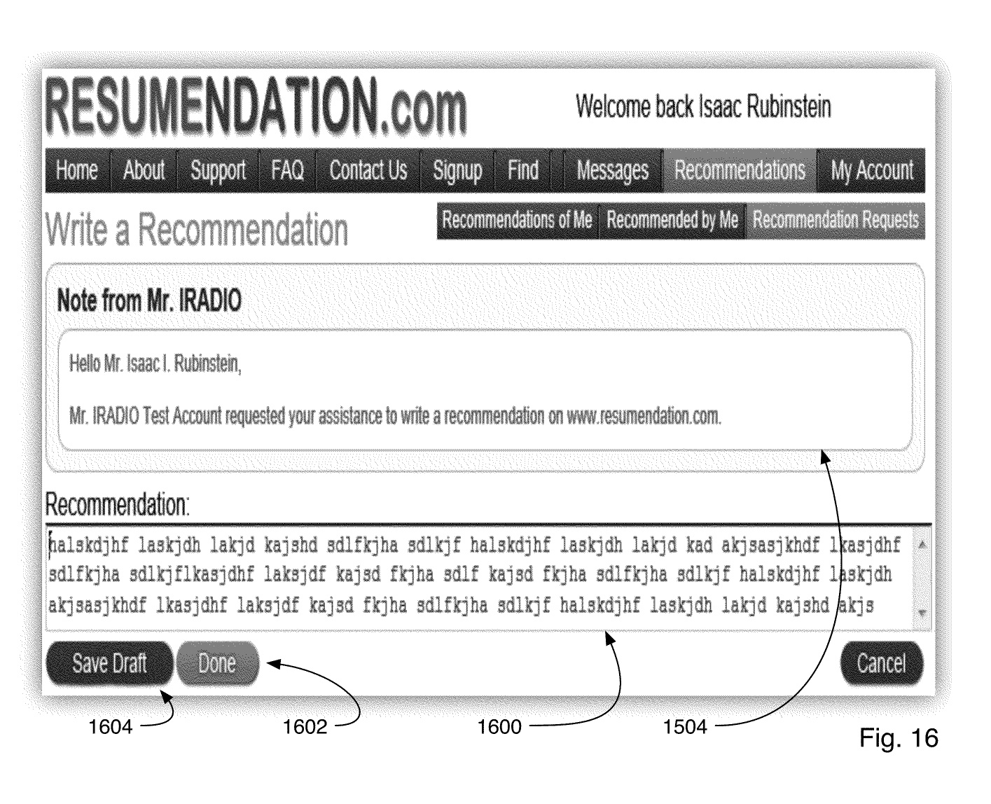

With reference to FIG. 16, this is a web page view of the Write a Recommendation form used by the recommender 400 to write a recommendation for a anonymous individual 100 known to the recommender 400. The form contains the original message 1504 from the New Recommendation Request form, an edit area 1600 where the actual recommendation text can be entered, and a Done button 1602 that when clicked completes the recommendation process by making the recommendation available to the recommended party 100. The recommended party 100 can include the recommendation in the public profile, if desired. Clicking on Save Draft button 1604 saves the recommendation text for further editing without making the recommendation available to the recommended party 100.

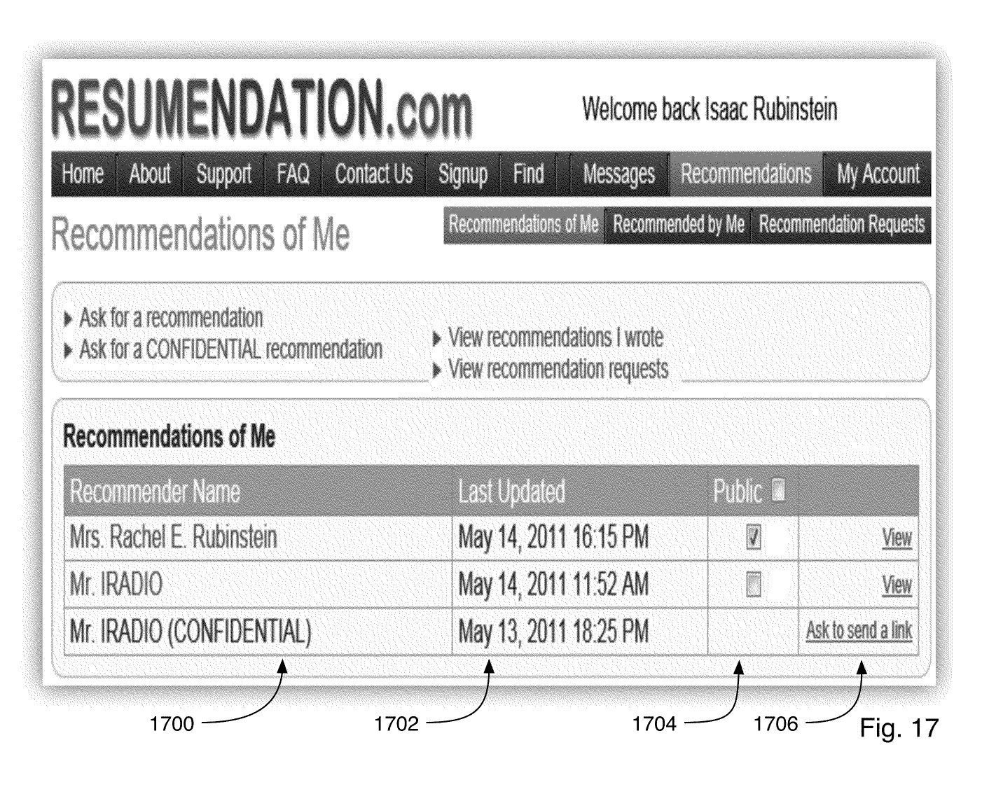

With reference to FIG. 17, this is a web page view of the Recommendations of Me page showing all recommendations received by the user (anonymous individual 100), in a grid view, each row representing a recommendation.

Recommender Name column 1700 contains the name of the recommender. Last Updated column 1702 contains the date when the recommendation was last updated.

If the recommendation is a regular recommendation as opposed to confidential recommendation, then Public column 1704 contains a checkbox that determines whether the recommendation is included in the recommended anonymous individual's 100 public profile. Also, the command column 1706 contains a View link that enables the recommended individual to view the contents of the recommendation.

If the recommendation is a confidential recommendation, then the Public column 1704 does not contain a checkbox, and the command column 1706 contains an “Ask to send a link” button. Clicking on the “Ask to send a link” button enables the recommended individual 100 to ask the recommender 400 to forward to a potential employer 102 (or to an other third party 402) a link that points to the confidential recommendation.

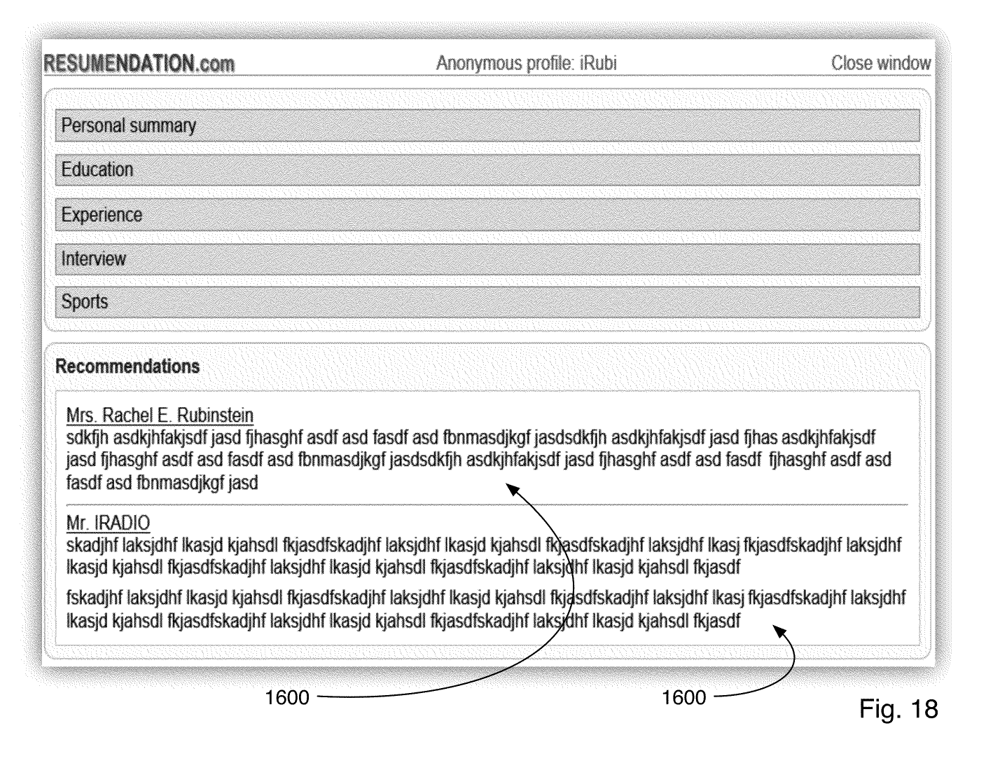

With reference to FIG. 18, this is a web page view of the public profile of an anonymous individual 100, showing the regular (non-confidential) recommendations 1600 that the anonymous individual 100 chose to make public.

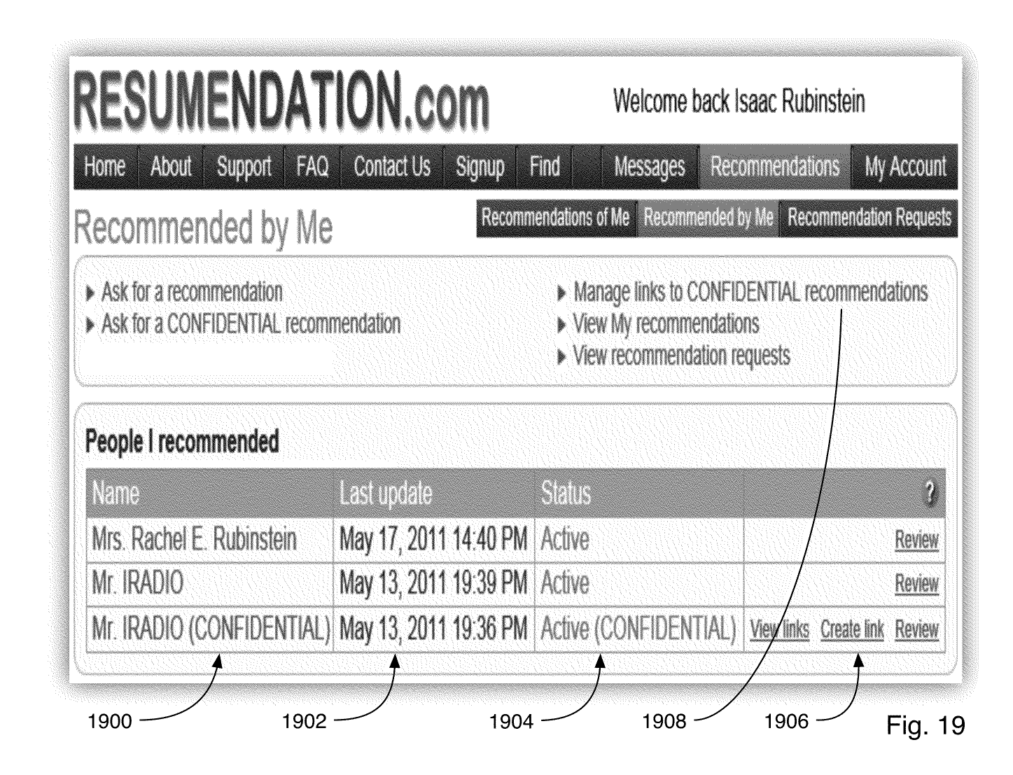

FIG. 19 is a web page view of the Recommended by Me page showing all recommendations written by the user 400 (the recommender) that is logged in to the system.

Name field 1900 contains the name of the recommended anonymous individual 100, known to the recommender. Last update field 1902 contains the date that the recommendation was last updated. Status field 1904 contains the status of each recommendation that can be either Active or Suspended. The Status field 1904 also marks all confidential recommendations with the text “(CONFIDENTIAL)”.

Commands field 1906 contains a Review button for all recommendations. Clicking on the Review button displays the recommendation. In case of a confidential recommendation, the Commands field 1906 also contains a View Links button, and a Create link button. Clicking on the Create link button creates a new link that points to a confidential recommendation. Clicking on the View links button displays all links to this specific confidential recommendation.

Clicking on “Manage links to CONFIDENTIAL recommendations” 1908 displays all links to all confidential recommendations written by the logged in user (recommender) 400.

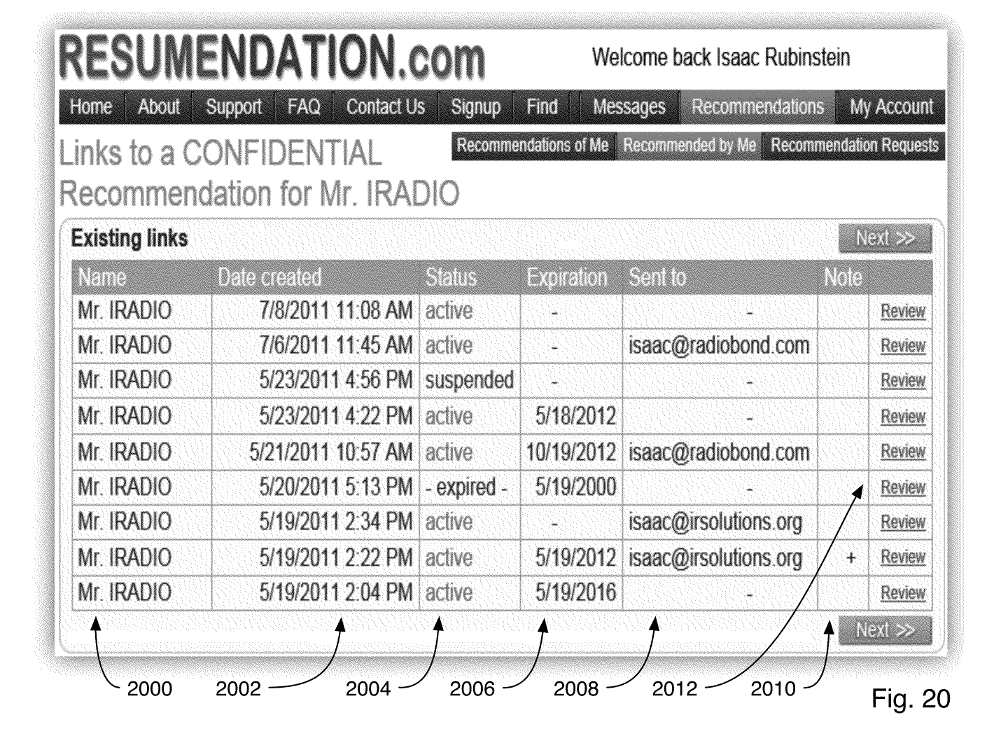

FIG. 20 is a web page view of a Links to a CONFIDENTIAL Recommendation page showing all links to a specific confidential recommendation written for a known anonymous individual 100 by the recommender 400 that is logged in to the system.

Name field 2000 contains the name of the recommended anonymous individual 100, known to the recommender 400. Date created field 2002 contains the date when the link was created. Status field 2004 contains the status of the link, and can be one of active, suspended, or expired. Expiration field 2006 contains an optional expiration date of a link. If a link was emailed to a potential employer 102 or to an other third party 402 using the system, then the Sent to field 2008 contains the email address of the recipient of the link. If the link includes a personalized note, then the Note field 2010 contains a “+” mark. The command field 2012 contains a Review button that enables the recommender 400 to review an existing link.

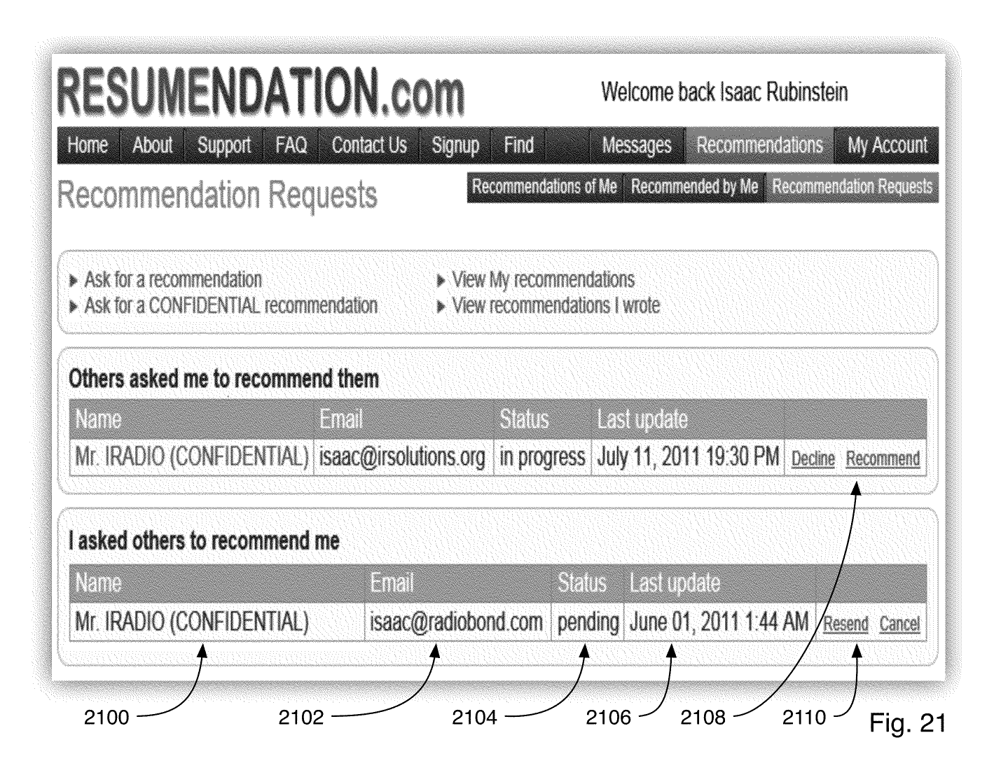

FIG. 21 is a web page view of a Recommendation Requests page showing two sections: an “Others asked me to recommend them” section having a list of all recommendation requests from other anonymous individuals 100 known to the recommender 400 that is logged into the system (the user), the other anonymous individuals asking for a recommendation. Also shown is an “I asked others to recommend me” section having a list of all recommendation requests by the anonymous individual 100 that is logged into the system (the user), asking a recommender 400 to recommend the anonymous individual 100 that is logged in to the system.

Name field 2100 contains the name of the recommended individual or the recommending individual. Email field 2102 contains the email address of the recommended individual or the recommending individual. Status field 2104 contains the status of the recommendation. Last update field 2106 contains the date and time when the recommendation was last updated.

Command field 2108 contains a Decline button and a Recommend button. Clicking the Decline button removes the recommendation request from this list. Clicking the Recommend button enables the recommender (the logged in user) to write a recommendation.

Command field 2110 contains a Resend button and a Cancel button. Clicking the Resend button resends the recommendation request. Clicking the Cancel button cancels the recommendation request.

Other modifications and implementations will occur to those skilled in the art without departing from the spirit and the scope of the invention as claimed. Accordingly, the above description is not intended to limit the invention except as indicated in the following claims.

What is claimed is:

1. A website for helping a recommender to provide confidential recommendations for individuals, the website comprising:
a recommendation creation capability for use by a recommender for enabling the recommender to create a confidential recommendation;
a recommendation link creation capability for use by the recommender for enabling the recommender to create the link to the confidential recommendation; and
a recommendation link control capability for use by the recommender for controlling the link to the confidential recommendation.

2. The website of claim 1, further comprising:
a recommendation creation request capability for use by an individual for sending to a recommender a request to create the confidential recommendation.

3. The website of claim 1, further comprising:
a recommendation forward request capability for use by an individual for sending a request to the recommender to forward a link to the content of the confidential recommendation to a third party.

4. The website of claim 1, further comprising:
a recommendation link sending capability for use by the recommender for sending the link to the confidential recommendation to the third party.

5. The website of claim 1, wherein the recommendation creation capability for use by a recommender for enabling the recommender to create the confidential recommendation includes an upload capability for uploading the confidential recommendation to the website.

6. The website of claim 1, wherein the recommendation link control capability for use by the recommender for controlling the link to the confidential recommendation includes a capability for at least one of:
changing the link expiration date;
changing the content pointed to by the link;
temporarily suspending a link;
re-activating a link; and
deleting a link.

7. The website of claim 1, further comprising:
a recommendation link actuating capability for use by the third party for actuating the link so as to display the confidential recommendation.

8. A website for helping a recommender to provide confidential recommendations for individuals, the website comprising:
a recommendation creation capability for use by a recommender for enabling the recommender to create a confidential recommendation;
a recommendation link creation capability for use by the recommender for enabling the recommender to create the link to the confidential recommendation; and
a recommendation link control capability for use by the recommender for controlling the link to the confidential recommendation, the recommendation link control capability including a capability for at least one of:
changing the link expiration date;
changing the content pointed to by the link;
temporarily suspending a link;
re-activating a link; and
deleting a link.

9. The website of claim 8, further comprising:
a recommendation creation request capability for use by an individual for sending to a recommender a request to create the confidential recommendation.

10. The website of claim 8, further comprising:
a recommendation forward request capability for use by an individual for sending a request to the recommender to forward a link to the content of the confidential recommendation to a third party.

11. The website of claim 8, further comprising:
a recommendation link sending capability for use by the recommender for sending the link to the confidential recommendation to the third party.

12. The website of claim 8, wherein the recommendation creation capability for use by a recommender for enabling the recommender to create the confidential recommendation includes an upload capability for uploading the confidential recommendation to the website.

13. The website of claim 8, further comprising:
a recommendation link actuating capability for use by the third party for actuating the link so as to display the confidential recommendation.

14. A method for helping a recommender to provide confidential recommendations for individuals, the method comprising:
providing a recommendation creation capability for use by a recommender for enabling the recommender to create a confidential recommendation;
providing a recommendation link creation capability for use by the recommender for enabling the recommender to create the link to the confidential recommendation; and
providing a recommendation link control capability for use by the recommender for controlling the link to the confidential recommendation.

15. The method of claim 14, further comprising:
providing a recommendation creation request capability for use by an individual for sending to a recommender a request to create the confidential recommendation.

16. The method of claim 14, further comprising:
providing a recommendation forward request capability for use by an individual for sending a request to the recommender to forward a link to the content of the confidential recommendation to a third party.

17. The method of claim 14, further comprising:
providing a recommendation link sending capability for use by the recommender for sending the link to the confidential recommendation to the third party.

18. The method of claim 14, wherein providing the recommendation creation capability for use by a recommender for enabling the recommender to create the confidential recommendation includes providing an upload capability for uploading the confidential recommendation to the website.

19. The method of claim 14, wherein providing the recommendation link control capability for use by the recommender for controlling the link to the confidential recommendation includes providing a capability for at least one of:
changing the link expiration date;
changing the content pointed to by the link;
temporarily suspending a link;
re-activating a link; and
deleting a link.

20. The method of claim 14, further comprising:
providing a recommendation link actuating capability for use by the third party for actuating the link so as to display the confidential recommendation.
